(19) United States
(12) Patent Application Publication
(10) Pub. No.: US 2017/0041415 A1
(43) Pub. Date: Feb. 9, 2017

(54) Method And System For Instant Information Push In A Network Information Service System

(71) Applicant: Taixing Zhihan Technology Co., Ltd., Taixing (CN)

(72) Inventor: Qiang ZHOU, Beijing (CN)

(21) Appl. No.: 14/836,650

(22) Filed: Aug. 26, 2015

(30) Foreign Application Priority Data
Aug. 6, 2015 (CN) 201510478638.0

(51) Int. Cl. H04L 29/08; G06F 17/30

(52) U.S. Cl. CPC H04L 67/26; H04L 67/1097; G06F 17/30864

(57) ABSTRACT

The present disclosure provides a method and a system for instant information push in a network information service system, comprising: sending distributed information to a system server via one user terminal, by an information distribution user assigned by a system; sending information in need to the system server via another user terminal, by an information-needs user; the distributed information and the information in need comprise a tag group with a tag; searching for the information being stored in a storage device according to the tag group comprised therein, by the system server, if the system server receives the information in need or the distributed information; sending the distributed information to the user terminal via which the information in need is sent, and allowing the information-needs user to follow the information distribution user, if it is searched out that the tag groups comprised completely or partially match each other. Thus, the present disclosure provides a device that promptly acquires useful information once the information is distributed. The present disclosure further provides a corresponding system.

### CROSS-REFERENCE TO RELATED APPLICATION

This application claims the benefit and priority of Chinese Patent Application No. 201510478638.0 filed Aug. 6, 2015. The entire disclosure of the above application is incorporated herein by reference.

### FIELD

The present disclosure relates to the field of a network information service, in particular, to a method and a system for instant information push in a network information service system.

### BACKGROUND

This section provides background information related to the present disclosure which is not necessarily prior art.

Existing network information search services, including search engines and electronic commerce websites, are flooded by a significant amount of spams, nevertheless, information which is really useful for searchers are buried among the spam information. A facility and a platform capable of accurately searching for information in need are required by the users.

Especially in the field of electronic commerce, commodities and services, not in mass production but produced on a small scale, are buried among a large amount of information about mass-production products with similar keywords. The mass-production products and services are capable of constantly conveying product information over the Internet by virtue of having advantages of production scales, but such information is regarded as spam by users who are searching for a personalized product or a service that is not in mass production. A facility and a platform, capable of accurately searching for products and services that are not in mass production, are required by the users.

The information for the products and services that are not in mass production is timely due to the discontinuity thereof. For example, sale information of a collection is valid to its potential buyers only for a period in which the collection completes its transaction, starting from the sale. Once the transaction has been made, the sale information will be invalid for its potential buyers even if it can be found over the Internet. Meanwhile, an information distributor anticipates that all those who plan to purchase the collection are capable of immediately acquiring it within the term of validity. Additionally, because the information distributor tends to continuously distribute the information of the same type, a person acquiring interested information is likely to expect following other information distributed why the same information distributor. Therefore, a facility, which enables information in need for the users to be sent to them simultaneously when the information is distributed, is desirable for the users, meanwhile, it enables information distributed by the users to be sent to those in need of it simultaneously when the information is distributed. People also are in need of the facility in being capable of continuously following other information distributed by the information distributor.

If the users require some timely information, with the current search methods, it is possible to continuously search for it until it is distributed by someone. Accordingly, a facility, capable of immediately acquiring the useful information when it is distributed, is required.

### SUMMARY

This section provides a general summary of the disclosure, and is not a comprehensive disclosure of its full scope of all of its features.

The present disclosure addresses the problem of timely sending to the users who are in need of information of products and services that are not in mass production.

In view of this, the present disclosure provides a method for information distribution and instant information receiving in a network information service, including the steps of:

A. sending distributed information to a system server via a user terminal, by an information distribution user assigned by a system, where the distributed information is stored in a storage device of the system server and includes one tag group, with a tag selected from a tag list of the system server, and a data package including at least a type of a text, an image, or a video;

B. sending information in need to the system server via another user terminal, by an information-needs user, where the information in need is stored in the storage device of the system server and includes another tag group with a tag selected from the tag list of the system server;

C. searching for the distributed information being stored in the storage device according to the tag group included in the information in need, by the system server, if the system server receives the information in need; sending the distributed information to the user terminal via which the information in need is sent, if the distributed information is searched out such that the tag group, which is included therein, completely or partially matches the tag group included in the information in need;

D. searching for the information in need being stored in the storage device according to the tag group included in the distributed information, by the system server, if the system server receives the distributed information; sending the distributed information to the user terminal via which the information in need is sent, if the information in need is searched out such that the tag group, which is included therein, completely or partially matches the tag group included in the distributed information;

where the “completely matches” indicates that each tag in the tag group included in the distributed information are identical to the respective tag in the tag group included in the information in need, and the “partially matches” indicates that not every tag in the tag group included in the distributed information is identical to the respective tag in the tag group included in the information in need; and

E. setting the information distribution user as “Follow”, who distributes the distributed information with a completely or partially match after being searched for, by the information-needs user, thereby once the system server receives the distributed information sent by the information distribution user who is set to “Follow”, the system server checks whether the tag group included in the distributed information completely or partially matches the tag group that is selected by the information-needs user when he or she sets the information distribution user to “Follow”; and if the tag group included in the distributed information completely or partially matches the tag group, the system server sends the distributed information to the user terminal by the information-needs user who is set to “Follow”.

Preferably, the distributed information is timely information.

Preferably, the distributed information and the information in need further include category information, according to which and the tag group included in either the information in need or the distributed information, the system server conducts a search in C and D.

Preferably, a category in a category list is sorted by a first letter of a category name, and the tag in the tag list of each category is sorted by the number of times the tag being selected in a descending order.

Furthermore, after a category is selected and under which the tag in the tag list is selected by the information-needs user or the information distribution user on his or her user terminal, other tags in the tag list under the category are re-sorted by the number of times the tags being selected in a descending order, under a condition that the other tags in the tag list are selected.

Furthermore, the information-needs user and the information distribution user define one or more tags, and if the defined tags are absent in the present tag list, the defined tags are automatically added to the tag list.

Preferably, the system allows the information-needs user to set blocks for the information distribution user from whom the information-needs user receives information with the completely or partially matching tag group; and the system does not send the distributed information to the user terminal of the information-needs user, if, after setting block, it is searched out that the distributed information, with the tag group completely or partially matching the tag group included in the information in need sent subsequently by the information-needs user, is sent by the information distribution user.

Furthermore, the system counts a numbers of times that each information distribution user is blocked by respective information-needs users and counts a number of pieces of distributed information by the information distribution user respectively, wherein other information-needs users are capable of setting blocks in view of a counting result.

Furthermore, the system sets the respective information-needs users to block an information distribution user, if a ratio of the number of times that the information distribution user is blocked by the respective information-needs users to the number of pieces of distributed information of the information distribution user reaches a threshold.

Furthermore, the tag list of the system server includes a tag of a product name that correspondingly matches a bar code, where the information-needs user or the information distribution user, via the user terminal, scans the bar code and thereby selects the tag that matches the bar code and the selected tags forms a whole or a subset of the selected tag list.

The present disclosure further provides a system for performing the above method. The system includes a system server and user terminals that are connected to a network, where the system server includes a controller and a storage device, and the system further includes:

A. storing distributed information in the storage device, by the controller, if an information distribution user sends the distributed information to the system server via a user terminal, where the distributed information includes one tag group, with a tag selected from a tag list of the system server, and a data package including at least one type of a text, an image, or a video;

B. storing information in need in the storage device of the system server, by the controller, if an information-needs user sends the information in need to the system server via another user terminal, where the information in need includes another tag group with a tag selected from the tag list of the system server;

C. searching for the distributed information being stored in the storage device according to the tag group included in the information in need, by the controller, if the system server receives the information in need; sending the distributed information to the user terminal via which the information in need is sent, by the controller, if the distributed information is searched out such that the tag group, which is included therein, completely or partially matches the tag group included in the information in need;

D. searching for the information in need being stored in the storage device according to the tag group included in the distributed information, by the controller, if the system server receives the distributed information; sending the distributed information to the user terminal via which the information in need is sent, by the controller, if the information in need is searched out such that the tag group, which is included therein, completely or partially matches the tag group included in the distributed information;

where the “completely matches” indicates that each tag in the tag group included in the distributed information are identical to the respective tag in the tag group included in the information in need, and the “partially matches” indicates that not every tag in the tag group included in the distributed information is identical to the respective tag in the tag group included in the information in need; and

E. setting the information distribution user as “Follow”, who distributes the distributed information with a completely or partially match after being searched for, by the information-needs user, thereby once the system server receives the distributed information sent by an information distribution user who is set to “Follow”, the system server checks whether the tag group included in the distributed information completely or partially matches the tag group that is selected by the information-needs user when he or she sets the information distribution user to “Follow”; and if the tag group included in the distributed information completely or partially matches the tag group that is selected by the information-needs user, the system server sends the distributed information to the user terminal by the information-needs user who is set to “Follow”.

Thus, the present disclosure provides the users with a facility, which enables information in need for the users to be sent to them simultaneously when the information is distributed, the facility enables information distributed by the users to be sent to those in need of it simultaneously when the information is distributed. Additionally, the facility enables the information-needs user to continuously follow other information distributed by the information distribution user.

Further areas and aspects of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a configuration of a system server according to an embodiment of the present disclosure;

FIG. 2A to FIG. 2D illustrate views in which distributed information of a user terminal is set according to the embodiment of the present disclosure;

FIG. 3 illustrates a view in which information in need at the user terminal is set according to the embodiment of the present disclosure; and

FIG. 4 illustrates a flow chart of a method for information distribution and instant information receiving according to an embodiment of the present disclosure.

### DETAILED DESCRIPTION

Example embodiments will now be described more fully with reference to the accompanying drawings.

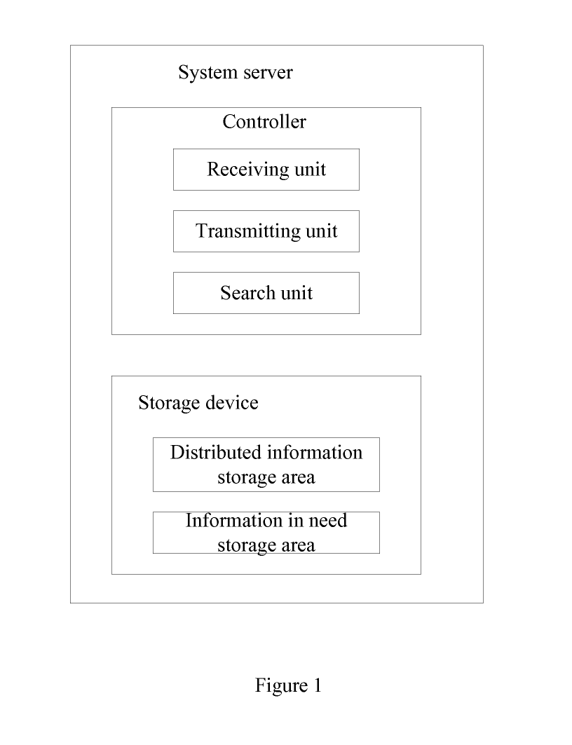

According to the present disclosure, a system for information distribution and instant information receiving in a network information service includes a system server and user terminals that are connected to a network. FIG. 1 illustrates a configuration of the system server according to an embodiment of the present disclosure. As illustrated in FIG. 1, the system server includes a controller and a storage device. The controller includes a receiving unit, a transmitting unit, and a search unit. Distributed information and information in need, which are received by the receiving unit, are stored in a distributed information storage area of the storage area and an information in need storage area of the storage device, respectively. The system can specify that only one or more IDs are capable of distributing information. The system can also define that only IDs satisfying some criteria are capable of distributing information.

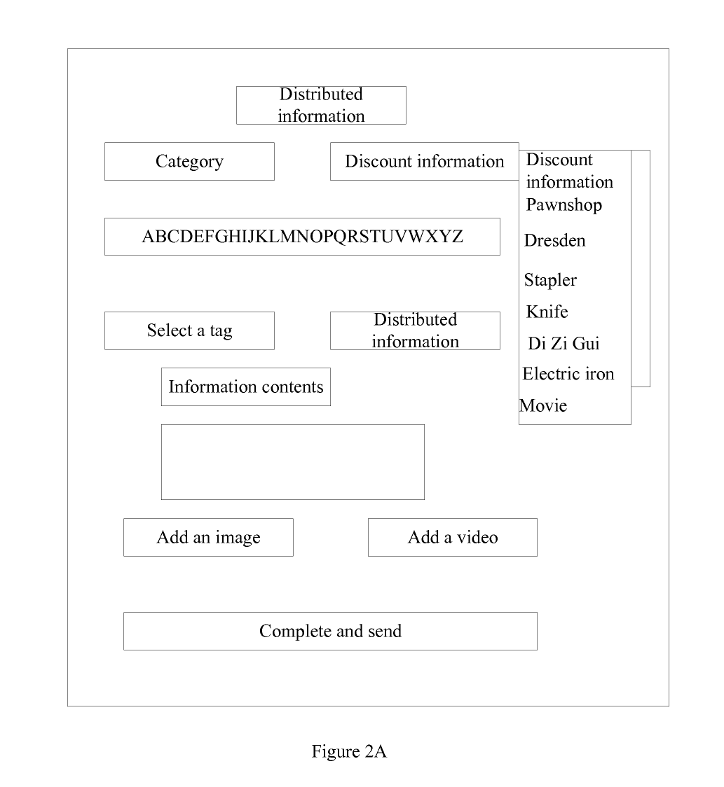

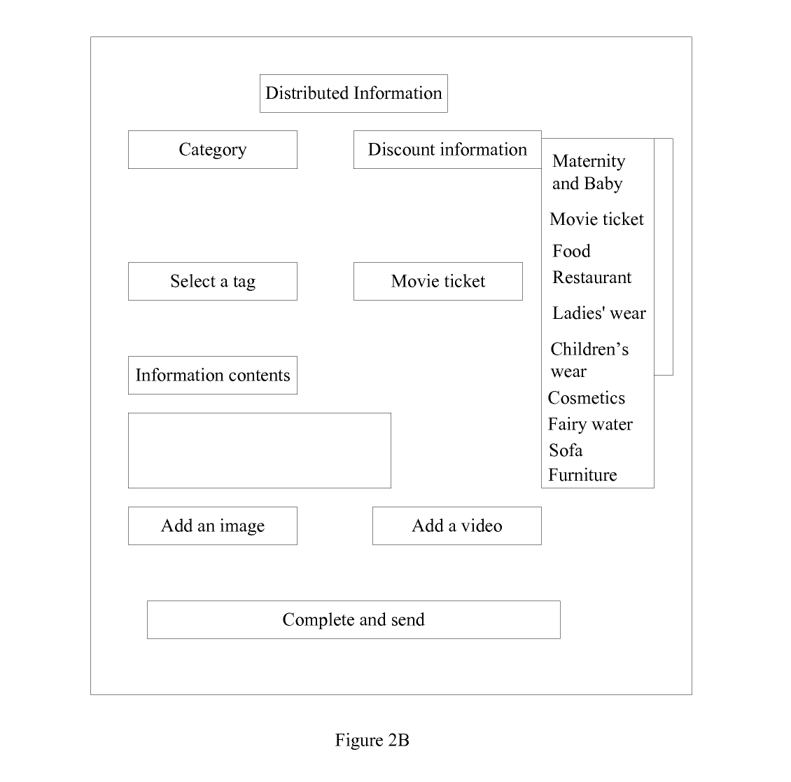

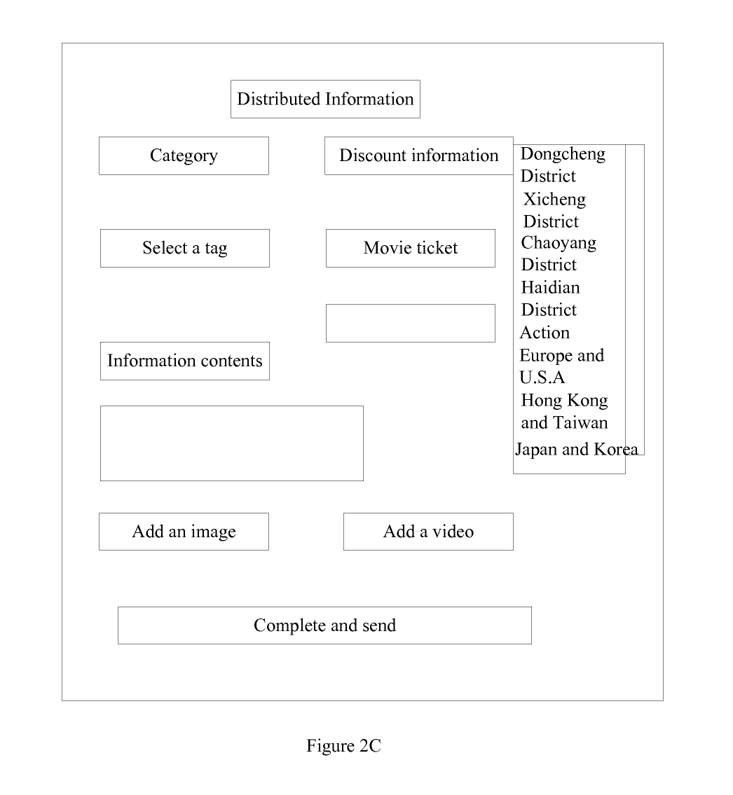

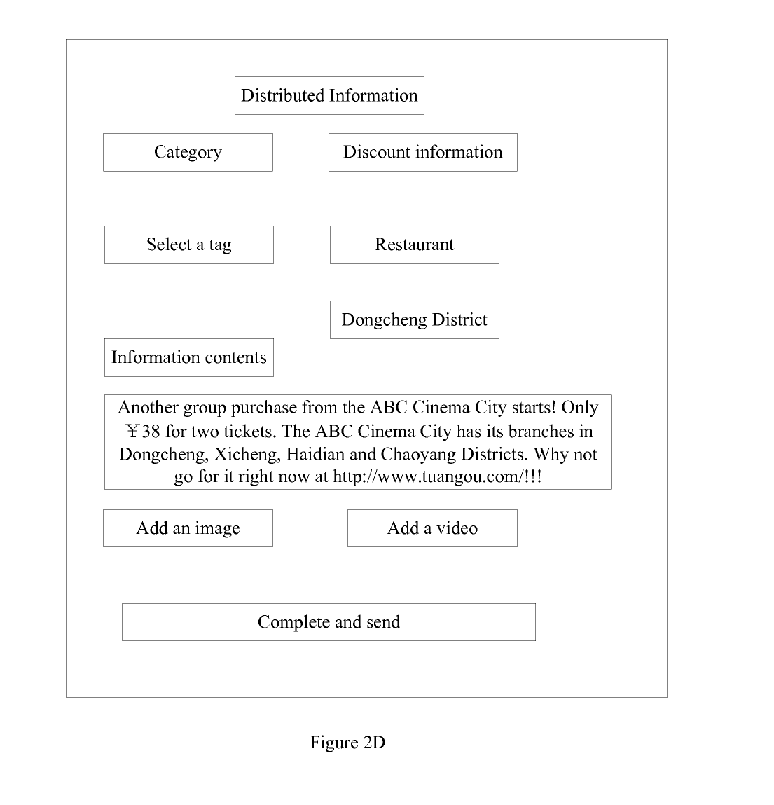

FIG. 2A to FIG. 2D illustrate views in which the distributed information at the user terminal is set according to the embodiment of the present disclosure. For example, the user terminal is a smartphone. Of course, alternatively, the user terminal can be a Personal Computer (PC), a laptop computer, a tablet computer, etc. As illustrated in FIG. 2A, if a user selects a category box, a category list next to the category box will be displayed. Using a scroll bar, the user can change a category displayed in the category list and can select a category in need. Alternatively, the category in need is displayed in the category list with a first letter, e.g., “D”, entered by the user. Then the user can select the category in need in the category list, e.g., “Discount information”. As illustrated in FIG. 2B, after the category is selected, if the user selects a tag box, a tag list corresponding to the selected category will be displayed next to the tag box. Using a scroll bar, the user can change a tag displayed in the tag list and can select a tag in need. Alternatively, the tag list in need is displayed in the tag list with a first letter, e.g., “C”, entered by the user. The user can select the tag in need. As illustrated in FIG. 2C, after the tag is selected, the user can continue selecting a tag, thus resulting in a tag group. The user can enter into the tag box a tag absent in the tag list. Thereafter as illustrated in FIG. 2D, the user can enter an information content into an information content box, and can add an image or a video. After the above setting is made, the user can click on a “Send” button. Then the distributed information can be sent to the system server. The distributed information is normally timely information.

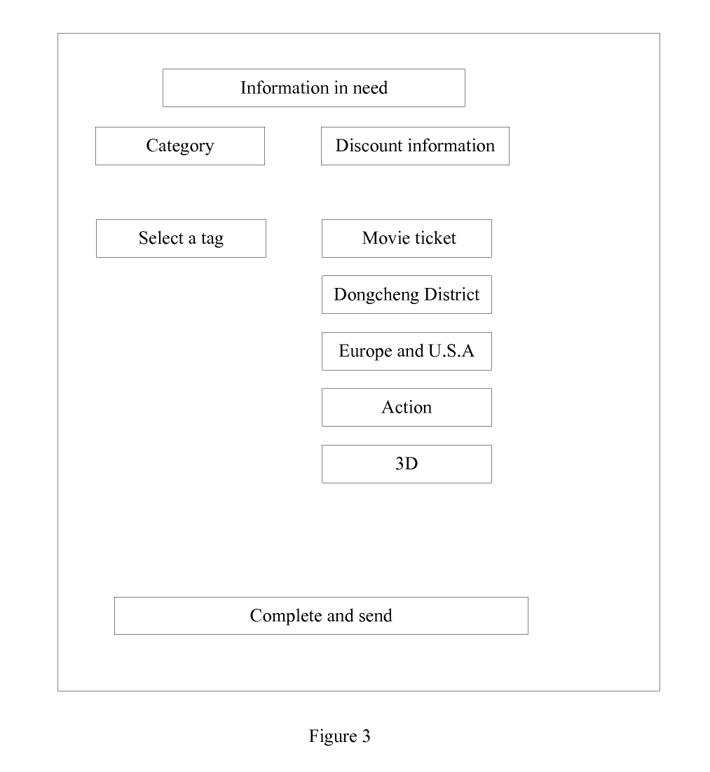

FIG. 3 illustrates a view in which the information in need at the user terminal is set according to the embodiment of the present disclosure. A setting of the information is similarly to a setting of the distributed information, except no added options regarding an information content, an image, and a video when setting the information in need for the user. The user can send the distributed information and the information in need, using the same tag list for selections.

Preferably, the category in the category list is sorted by a first letter of a category name, and the tag in the tag list of each category is sorted by times the tag being selected in a descending order.

The system server stores the distributed information and the information in need in the distributed information storage area and the information in need storage area of the storage device, respectively, upon receipt thereof via the receiving unit.

If the system server receives the information in need, the search unit of the controller thereof searches for the distributed information being stored in the distributed information storage area inside the storage device according to category information and the tag group included in the information in need. The transmitting unit of the controller sends the distributed information to the user terminal via which the information in need is sent, if the distributed information is searched out such that the tag group of the same category, which is included therein, completely or partially matches the tag group included in the information in need.

If the system server receives the distributed information, the search unit of the controller thereof searches for the information in need being stored in the information in need storage area inside the storage device according to category information and the tag group included in the distributed information. The transmitting unit of the controller sends the distributed information to the user terminal via which the information in need is sent, if the information in need is searched out such that the tag group of the same category, which is included therein, completely or partially matches the tag group included in the distributed information.

The completely matches indicates that all the tags of the tag group included in the distributed information are identical to the respective tags of the tag group included in the information in need, and the partially matches indicates that some of the tags of the tag group included in the distributed information are identical to the respective tags of the tag group included in the information in need.

The category in the category list is sorted by the first alphabet of the category name, and the tag in the tag list of each category is sorted by the times the tag being selected in a descending order.

After the category is selected and under which one or more tags in the tag list are selected by the information-needs user or the information distribution user on his or her user terminal, other tags in the tag list under the category are re-sorted by times the tags being selected in a descending order, under a condition that the one or more tags in the tag list are selected.

Preferably, the information-needs user can set the corresponding information distribution user, who completely or partially matches, to “Follow”. Thereafter once the system server receives the distributed information sent by the information distribution user who is set to “Follow”, the system server checks whether the tag group included in the distributed information completely or partially matches the tag group that is selected by the information-needs user when he or she sets the information distribution user to “Follow”; and if so, the system server sends the distributed information to the user terminal by the information-needs user who is set to “Follow”.

For example, if John, the information-needs user, sends the information in need to the system server, it is to be found that, after a search by the system, the distributed information sent by Jane, the information distribution user, completely or partially matches the tag group in the information in need sent by John. The system sends the distributed information by Jane to the user terminal by John. Meanwhile, John is very interested in the distributed information by Jane and has the desire to continuously acquire the distributed information by Jane. John may set Jane as “Follow” in the system. Therefore, once the system receives the distributed information sent thereto by Jane, it checks whether the tag group included in the distributed information completely or partially matches the tag group that is selected by John when he sets Jane to “Follow”; and if so, the system sends the distributed information to the user terminal by John.

Thus, the present disclosure provides the users with a facility, which enables information in need for the users to be sent to them simultaneously when the information is distributed, the facility enables information distributed by the users to be sent to those in need of it simultaneously when the information is distributed. Additionally, the facility enables the information-needs user to continuously follow other information distributed by the information distribution user.

According to the embodiment, the system can employ a credit mechanism for the information distribution user to distribute information. The system allows the information-needs user to block the information distribution user from whom the information-needs user receives information with the completely or partially matching tag group. if, after block, it is searched out that the distributed information, with the tag group completely or partially matching the tag group included in the information in need sent subsequently by the information-needs user, is sent by the information distribution user, the system will not send the distributed information to the user terminal by the information-needs user.

This is for the purpose of preventing the information distribution user from receiving a match of the information in need by sending falsely distributed information or spam distributed information, which would otherwise bring a poor use experience to the information-needs user.

Preferably, the system can count times that each information distribution user is blocked by respective information-needs users and counting a number of pieces of distributed information by the information distribution user, respectively, where other information-needs users are capable of setting blocks in view of a counting result.

Furthermore, the system can set that all the information-needs users block the information distribution user, if a ratio of the times that the information distribution user is blocked by the respective information-needs users to the number of pieces of distributed information of the information distribution user reaches a threshold.

For example, if the ratio, counted by the system, of the times that the information distribution user is blocked by the respective information-needs users to the number of pieces of distributed information of the information distribution user reaches 10:1, 50:1 or 100:1, the system will set that all the information-needs users block the information distribution user in an attempt to prevent the user from further sending any spams.

With the credit mechanism, the system can provide a more accurate information service, thereby avoiding distribution and propagation of the network spams as much as possible and enabling the information-needs user to obtain a better service experience.

According to another embodiment of the present disclosure, the tag list of the system server includes a tag of a product name that correspondingly matches a bar code, by the tag list of the system server, where the information-needs user or the information distribution user, via the user terminal, scans the bar code and selects the tag that matches the bar code and forms a whole or a subset of the selected tag list. The bar code is a globally uniform bar code, bringing convenience and efficiency for the user who selects to enter the tag in the tag list.

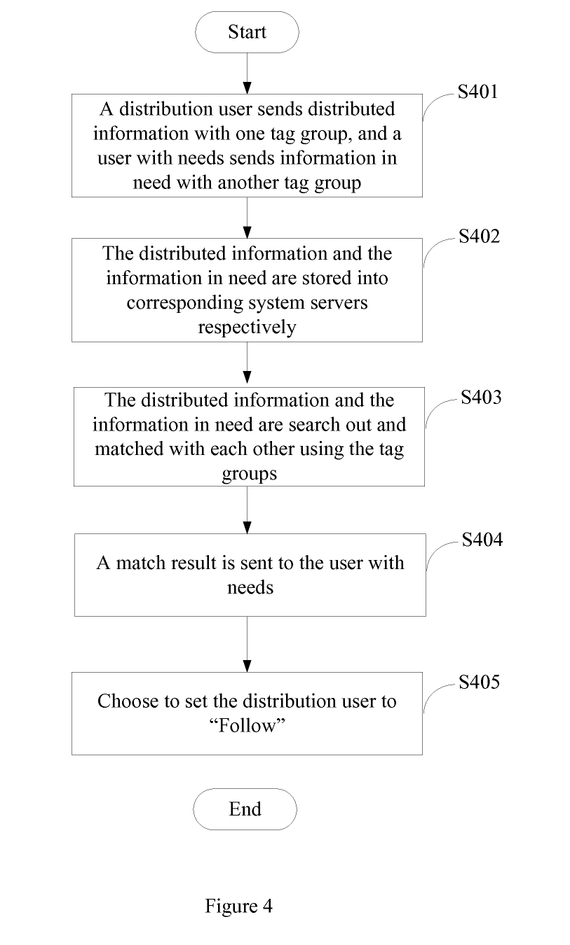

FIG. 4 illustrates a flow chart of a method for information distribution and instant information receiving according to an embodiment of the present disclosure. The method includes the following steps:

step S401: a distribution user sends distributed information with one tag group, and a user with needs sends information in need with another tag group.

The user with needs sends the information in need with the tag group, while the system indicates one or more information distribution users to send the distributed information to the system server via user terminals, where the distributed information includes the tag group including one or more tags, and a data package that includes at least one type of a text, an image, or a video.

The information-needs user sends the information in need to the system server via a user terminal, where the information in need includes the tag group with one or more tags.

Step S402: the distributed information and the information in need are stored into corresponding system servers respectively.

Step S403: the distributed information and the information in need are search out and matched with each other using the tag groups.

Step S404: a match result is sent to both of the distribution user and the user with needs.

If the system server receives the information in need, it searches for the distributed information being stored in the storage device according to the tag group included in the information in need. If the distributed information is searched out such that the tag group, which is included therein, completely or partially matches the tag group included in the information in need, the system server sends the distributed information to the user terminal via which the information in need is sent.

If the system server receives the distributed information, it searches for the information in need being stored in the storage device according to the tag group included in the distributed information. If the information in need is searched out such that the tag group, which is included therein, completely or partially matches the tag group included in the distributed information, the system server sends the distributed information to the user terminal via which the information in need is sent.

The completely matches indicates that all the tags of the tag group included in the distributed information are identical to the respective tags of the tag group included in the information in need, and the partially matches indicates that some of the tags of the tag group included in the distributed information are identical to the respective tags of the tag group included in the information in need.

Step S405: Set the information distribution user to “Follow”.

The information-needs user sets the information distribution user as “Follow”, who distributes the distributed information with a completely or partially match after being searched for. Therefore, once the system server receives the distributed information sent by the information distribution user who is set to “Follow”, the system server checks whether the tag group included in the distributed information completely or partially matches the tag group that is selected by the information-needs user when he or she sets the information distribution user to “Follow”; and if so, the system server sends the distributed information to the user terminal by the information-needs user who is set to “Follow”.

This will make it convenient for the user to continue tracking another user satisfying his or her need, thereby improving utilization of the platform.

The method is employed by a software installed on the system server and the user terminals. If the system server receives the tag list entered by the user in which there is no tag, the system server will automatically update the tag list on the user terminal. In addition, the system server will update the order of the tags in the tag list at the user terminal according to the times the tags are being selected.

Therefore, the present disclosure provides the users with “a facility that enables information in need for the users to be sent to them simultaneously when the information is distributed”, and “a facility that enables information distributed by the users to be sent to those in need of it simultaneously when the information is distributed”. Additionally, the facility enables the information-needs user to continuously follow other information distributed by the information distribution user.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for information distribution and instant information receiving in a network information service, comprising:
A. sending distributed information to a system server via a user terminal, by an information distribution user assigned by a system, wherein the distributed information is stored in a storage device of the system server and comprises one tag group, with a tag selected from a tag list of the system server, and a data package comprising at least a type of a text, an image, or a video;
B. sending information in need to the system server via another user terminal, by an information-needs user, wherein the information in need is stored in the storage device of the system server and comprises another tag group with a tag selected from the tag list of the system server;
C. searching for the distributed information being stored in the storage device according to the tag group comprised in the information in need, by the system server, if the system server receives the information in need; sending the distributed information to the user terminal via which the information in need is sent, if the distributed information is searched out such that the tag group, which is comprised therein, completely or partially matches the tag group comprised in the information in need;
D. searching for the information in need being stored in the storage device according to the tag group comprised in the distributed information, by the system server, if the system server receives the distributed information; sending the distributed information to the user terminal via which the information in need is sent, if the information in need is searched out such that the tag group, which is comprised therein, completely or partially matches the tag group comprised in the distributed information;
where the “completely matches” indicates that each tag in the tag group comprised in the distributed information are identical to the respective tag in the tag group comprised in the information in need, and the “partially matches” indicates that some of the tags in the tag group comprised in the distributed information are identical to the respective tags in the tag group comprised in the information in need; and
E. setting the information distribution user as “Follow”, who distributes the distributed information with a completely or partially match after being searched for, by the information-needs user, thereby once the system server receives a distributed information sent by the information distribution user who is set to “Follow”, the system server checks whether the tag group comprised in the distributed information completely or partially matches the tag group that is selected by the information-needs user when he or she sets the information distribution user to “Follow”; and if the tag group comprised in the distributed information completely or partially matches the tag group that is selected by the information-needs user, the system server sends the distributed information to the user terminal by the information-needs user who is set to “Follow”.

2. The method according to claim 1, wherein the distributed information is timely information.

3. The method according to claim 1, wherein the distributed information and the information in need further comprise category information, according to which and the tag group comprised in either the information in need or the distributed information, the system server conducts a search in step C and D.

4. The method according to claim 3, wherein a category in a category list is sorted by a first letter of a category name, and the tag in the tag list of each category is sorted by number of times the tag being selected in a descending order.

5. The method according to claim 3, wherein after a category is selected and under which the tag in the tag list is selected by the information-needs user or the information distribution user on his or her user terminal, other tags in the tag list under the category are re-sorted by number of times the other tags being selected in a descending order, under a condition that the tag in the tag list are selected.

6. The method according to claim 3, wherein the information-needs user and the information distribution user define one or more tag, and if the defined tags are absent in the present tag list, the defined tags are automatically added to the tag list.

7. The method according to claim 1, wherein the method further comprises:
allowing the information-needs user to set blocks for an information distribution user from whom the information-needs user receives information with the completely or partially matching tag group, by the system; and
not sending a distributed information to the user terminal of the information-needs user after setting blocks, if it is searched out that the distributed information, with the tag group completely or partially matching the tag group comprised in the information in need sent subsequently by the information-needs user, is sent by the information distribution user.

8. The method according to claim 7, wherein the method further comprises:
counting a number of times that each information distribution user is blocked by respective information-needs users and counting a number of pieces of distributed information by the information distribution user, respectively by the system, wherein other information-needs users are capable of setting blocks in view of a counting result.

9. The method according to claim 8, wherein the method further comprises:
setting the respective information-needs users to block an information distribution user, by the system, if a ratio of the number of times that the information distribution user is blocked by the respective information-needs users to the number of pieces of distributed information of the information distribution user reaches a threshold.

10. The method according to claim 1, wherein the method further comprises:
the tag list of the system server comprising a tag of a product name that correspondingly matches a bar code, wherein the information-needs user or the information distribution user, via a user terminal, scans the bar code, and thereby selects the tag that matches the bar code and the selected tags form a whole or a subset of the selected tag list.

11. A system for information distribution and instant information receiving in a network information service, comprising a system server and user terminals that are connected to a network, wherein the system server comprising a controller and a storage device, and the system further comprises:
A. storing distributed information in the storage device, by the controller, if an information distribution user sends the distributed information to the system server via a user terminal, wherein the distributed information comprises one tag group, with a tag selected from a tag list of the system server, and a data package comprising at least one type of a text, an image, or a video;
B. storing information in need in the storage device of the system server, by the controller, if an information-needs user sends the information in need to the system server via another user terminal, wherein the information in need comprises another tag group with a tag selected from the tag list of the system server;
C. searching for the distributed information being stored in the storage device according to the tag group comprised in the information in need, by the controller, if the system server receives the information in need; sending the distributed information to the user terminal via which the information in need is sent, by the controller, if the distributed information is searched out such that the tag group, which is comprised therein, completely or partially matches the tag group comprised in the information in need;
D. searching for the information in need being stored in the storage device according to the tag group comprised in the distributed information, by the controller, if the system server receives the distributed information; sending the distributed information to the user terminal via which the information in need is sent, by the controller, if the information in need is searched out such that the tag group, which is comprised therein, completely or partially matches the tag group comprised in the distributed information;
wherein the “completely matches” indicates that each tag in the tag group comprised in the distributed information are identical to the respective tag in the tag group comprised in the information in need, and the “partially matches” indicates that some of the tags in the tag group comprised in the distributed information are identical to the respective tag in the tag group comprised in the information in need; and
E. setting the information distribution user as “Follow”, who distributes the distributed information with a completely or partially match after being searched for, by the information-needs user, thereby once the system server receives the distributed information sent by the information distribution user who is set to “Follow”, the system server checks whether the tag group comprised in the distributed information completely or partially matches the tag group that is selected by the information-needs user when he or she sets the information distribution user to “Follow”; and if the tag group comprised in the distributed information completely or partially matches the tag group that is selected by the information-needs, the system server sends the distributed information to the user terminal by the information-needs user who is set to “Follow”.
